(19) United States
(12) Patent Application Publication
(10) Pub. No.: US 2014/0320504 A1
(43) Pub. Date: Oct. 30, 2014

(54) Virtual Re-Animation

(71) Applicant: TAMM, Inc., Bloomfield, CT (US)

(72) Inventors: Timothy Maloney, Avon, CT (US); Matthew Connell-Giammatteo, Bloomfield, CT (US); Gerald Stanton, Farmington, CT (US)

(73) Assignee: TAMM, Inc., Bloomfield, CT (US)

(21) Appl. No.: 13/873,280

(22) Filed: Apr. 30, 2013

(51) Int. Cl. G06T 13/00

(52) U.S. Cl. CPC G06T 13/00
USPC 345/473

(57) ABSTRACT

Exemplary embodiments of the invention provide a method, apparatus and computer readable memory for presenting an interactive virtual rendition of a historical person. The method includes compiling a pre-fetch database about the historical person comprising one or more writings, audio and video records of or about the historical person and presenting a multimedia virtual rendering of the historical person, the rendering comprising at least audio content and at least one of personal mannerisms and personality traits derived from the pre-fetch database as attributed to the historical person. In this embodiment the method also comprises in response to real-time inputs from interaction with the virtual rendering of the historical person, using at least the pre-fetch database to compile a reply to the real time inputs, the compiled reply comprising at least one of audio content and personal mannerisms that are selected and virtually rendered in dependence on the real-time inputs.

### CROSS-REFERENCE TO RELATED APPLICATION

This application claims the benefit of U.S. Provisional Application No. 61/687,786, filed on Apr. 30, 2012,

### TECHNICAL FIELD

This invention relates generally to rendering a virtual person from a database, such as for example an audio or audio-visual representation of a historical person rendered from that person's own writings and/or recorded actions and mannerisms as well as writings and analysis of that person by others.

### BACKGROUND

The information age has brought with it the capacity to store and access vast amounts of data. In addition to documents, which have been archived for a millennia, there are now audio and video recordings, which are available through the internet, This includes news footage and wholly private recordings posted on social media sites. Similar to documents, these audio and video recordings are digitally searchable by content.

Unlike conventional public libraries, this volume of data on the internet is not archived in a uniform way. Typical search engines perform a simple keyword search or match, adapted by algorithms that variously consider and weigh relevance and popularity. More complex database searches use massively parallel processors and/or artificial intelligence machines.

The combination of vast data storage and the ability to digitally search, gives rise to novel ways for assembling select pieces of data, and novel ways for presenting those search results to individuals and audiences. The teachings below follow this path.

### SUMMARY

In a first exemplary aspect of the invention there is a method for presenting an interactive virtual rendition of a historical person. In this aspect the method comprises compiling a pre-fetch database about the historical person comprising one or more writings, audio and video records of or about the historical person and presenting a multimedia virtual rendering of the historical person, the rendering comprising at least audio content and at least one of personal mannerisms and personality traits derived from the pre-fetch database as attributed to the historical person. In this aspect the method also comprises in response to real-time inputs from interaction with the virtual rendering of the historical person, using at least the pre-fetch database to compile a reply to the real time inputs, the compiled reply comprising at least one of audio content and personal mannerisms that are selected and virtually rendered in dependence on the real-time inputs.

In a second exemplary aspect of the invention there is an apparatus comprising a processing system. The processing system comprises at least one processor, and at least one memory including computer program code. The processing system is configured to cause the apparatus at least to compile a pre-fetch database about the historical person comprising one or more writings, audio and video records of or about the historical person and present a multimedia virtual rendering of the historical person, the rendering comprising at least audio content and at least one of personal mannerisms and personality traits derived from the pre-fetch database as attributed to the historical person. The processing system is configured to further cause the apparatus at least to in response to real-time inputs from interaction with the virtual rendering of the historical person, use at least the pre-fetch database to compile a reply to the real time inputs, the compiled reply comprising at least one of audio content and personal mannerisms that are selected and virtually rendered in dependence on the real-time inputs.

In a third exemplary aspect of the invention there is a computer readable memory tangibly storing a set of computer instructions comprising code. In this aspect when the code is executed on a processing system it causes the processing system at least to compile a pre-fetch database about the historical person comprising one or more writings, audio and video records of or about the historical person and present a multimedia virtual rendering of the historical person, the rendering comprising at least audio content and at least one of personal mannerisms and personality traits derived from the pre-fetch database as attributed to the historical person. The code when executed on the processing system is further configured to in response to real-time inputs from interaction with the virtual rendering of the historical person, use at least the pre-fetch database to compile a reply to the real time inputs, the compiled reply comprising at least one of audio content and personal mannerisms that are selected and virtually rendered in dependence on the real-time inputs.

These and other aspects are detailed below with more particularity.

### BRIEF DESCRIPTION OF THE DRAWINGS

FIG. 1 is a logic flow diagram that illustrates the operation of a method, operation of an apparatus and a result of execution by a processing system of a set of computer instructions embodied on a computer readable memory, in accordance with the exemplary embodiments of this invention.

FIG. 2 is a high level block diagram of an exemplary processing system suitable for use in practicing the exemplary embodiments of the invention.

### DETAILED DESCRIPTION

Exemplary embodiments of these teachings are directed toward mining data to assemble what were the actual or what is conjectured to be a historical person's thoughts, positions and teachings on a particular subject, and presenting those assembled thoughts, positions and teachings as if from the person him/herself in real time in response to queries or challenges from others. Another exemplary embodiment would be creating a presentation by the historical person him/herself on the topic on which he/she is famous. Great advantage is seen in using this technique to impart to the current generation the thoughts and teachings of great thinkers who are now deceased.

In each field of human endeavor there are a relatively small number of intellectual giants whose stature stands tall among multiple generations for their original thinking, regardless of whether their particular ideas fall in and out of favor. In physics Copernicus, Newton, Bohr, Plank and Einstein are among such original thinkers. Those whose ideas changed the world of politics include Socrates, Confucius, Cicero, Sun Tzu, Madison, Burke, Marx and Gandhi. From chemistry to medicine, and behavioral science to business and sports, every field of human endeavor has been greatly advanced by a relatively few original thinkers who are well known to those whose careers are grounded in that same field.

Exemplary embodiments of these teachings enable a physics class covering Newtonian mechanics to be taught by a virtual representation of Sir Isaac Newton himself; followed by a virtual Albert Einstein expounding on how Newtonian mechanics is wholly consistent with Einstein-ian relativity but for the special case in which relativistic effects are negligible. Exemplary embodiments further enable in this educational classroom setting the virtual Sir Newton to inquire the virtual Prof. Einstein to prove why his conclusions are not sheer speculation, and Einstein answering with the counterintuitive that it necessarily follows from the apparently unassailable premise that the speed of light is independent of one's own motion. The virtual great professor might explain further by recounting that he famously arrived at this insight during his time at the patent office in Bern. While riding a trolley moving away from a clock tower he considered what time he would observe on the clock if the trolley were travelling near the speed of the light being reflected from the clock face. Quantifying different observed times for different trolley speeds purportedly led to his insights into relativistic theory.

In embodiments of these teachings, the above exchange is not pre-programmed but instead is the result of mining data according to the teachings which are detailed further below, and in some embodiments at least some aspects of a virtual person's real time response arises from real-time inputs from the virtual Sir Newton (or from some living person if the exchange is not between two virtual persons). Since Prof. Einstein and Sir Newton never met in real life, the virtual Prof Einstein's responses are extrapolated from the historical record of the actual Prof Einstein, except where some response may be directly gleaned from the historical first-person record of the virtually rendered person him/herself.

In the exemplary embodiment above, the exchange might take a quite different turn if the virtual Prof. Einstein took a question from the audience rather than from the virtual Sir Newton, yet these teachings operate in the same way. Again exemplary embodiments mine data about the person to gage his/her response based on the historical record of the historical person whose virtual rendition is providing the response. The above embodiment shows just how powerful this technique can be to impart to the current generation some of the knowledge from or about historical persons that are stored and available in theory, but which might perhaps lay dormant or underappreciated in the vast sea of stored data that gives rise to the current times being termed the information age.

It should be noted that embodiments of these teachings are not limited to historical persons who are deceased. Exemplary embodiments enable a virtual historical person to be created who may otherwise not be able or available to present, discuss, or debate at a scheduled time or location. For instance, a graduate level physics class might want to have Stephen Hawking appear as a guest lecturer. However, Mr. Hawking's physical limitations or his schedule may prevent him from appearing in person. In this instance, embodiments of this invention would enable data mining of all Mr. Hawking's works, publications and related articles such that he could appear as a virtual rending. Accordingly, embodiments can be practiced wherein the historical person rendered is alive or deceased.

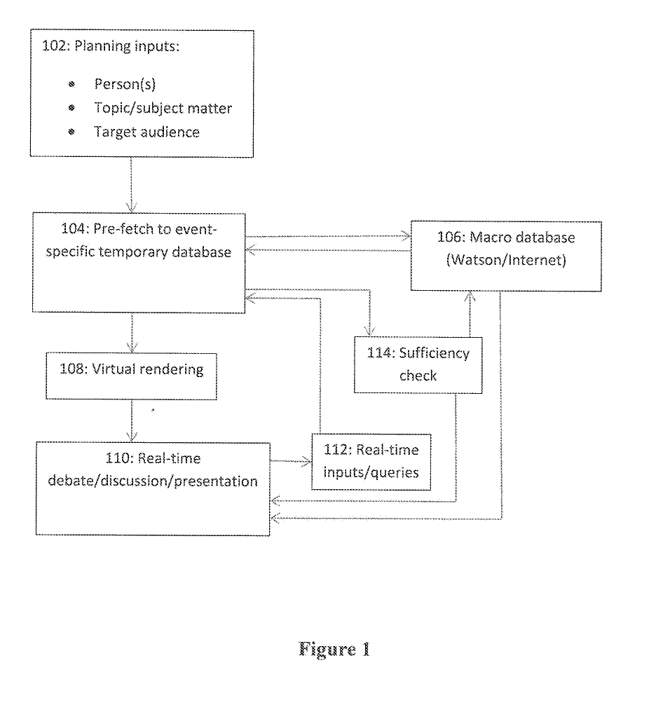

FIG. 1 is a process flow diagram that illustrates an exemplary non-limiting embodiment of this invention. The result of the process in FIG. 1 is a presentation, discussion or debate with, a historical person or persons on a select topic. The selected topic is typically known in advance, but can be selected at the time of the presentation, discussion or debate depending on the capability of the computing system being used. The process begins by taking inputs 102 the name of the historical person, the topic or subject matter which is to be the intended focus of the exchange, and possibly also the target audience. The target audience is helpful in searching the universe of data for situational relevance. For instance, if the above exchange between Einstein and Newton is intended for an introductory physics class that is mandatory for all second year undergraduate students, the most relevant data from which to render the historical person will be different from a target audience of physicists meeting to discuss the implications of recent experiments that tend to indicate neutrinos might be capable of exceeding the speed of light. It is also valuable to input the person or characteristics thereof against whom the first historical person might be debating or discussing. In the above example Einstein's foil for the exchange is Sir Isaac Newton. in another example where the virtual Prof. Einstein responds to queries from the audience a generic profile might be input as the debate partner, a profile not dissimilar from an average characteristic of the target audience for example.

Following inputs 102, relevant data for the presentation/debate/discussion is pre-fetched 104 and tangibly stored in an event-specific database. The relevant data may be copied from some searched source and stored again at this database. In another embodiment the pre-fetch database 104 may simply have pointers (for example internet addresses) of where the data that was selected by the pre-fetch process can be found. Another embodiment contains a hybrid of the above two examples, wherein only the most relevant portions of the source data that is identified in the pre-fetch process are stored in the pre-fetch database 104. In this embodiment a pointer associated with the pre-fetch portion is retained for ready access to the source data at some other digitally accessible location in case additional context or substance from the source data is needed for real-time response. This will be described in more detail below.

The pre-fetch database 104 can search the entire internet, or data which is pre-stored on a computing system or on an artificial intelligence (AI) computing system such as the IBM® Watson® system which in 2011 publicly proved its computing power by prevailing on an episode of the Jeopardy® game show while limiting its access to the system's own 4 TB database without access to the internet. Similar artificial intelligence/supercomputing systems include but are not limited to Deep Blue® and Blue Gene/Sequoia® (IBM®); K-computer® (Fujitsu®); Pleiades® (SGI®) and Tianhe-1A YH-MPP® (NUDT®). Such AI/supercomputing systems are not necessary for the pre-fetch 104 at this time because processing speed is not yet a critical concern. Accordingly, more pedestrian computing systems can be used for the pre-fetch 104, such as massive parallel processors without AI capability. Regardless of the specific system used for the pre-fetch 104, in exemplary embodiments, the universe of sources searched from a macro database 106 are chosen for the pre-fetch database 104 and archived there using relative weighing factors as detailed below.

In an exemplary embodiment the pre-fetch database 104 searches for first, second and third hand data that is relevant to the inputs 102. Where the historical and stored data is sufficient, the virtual rendition of the historical person taken from the pre-fetch database 104 presents that historical person's own conclusions on a particular matter. Examples of first hand data include the writings or video of Prof. Einstein himself and speeches by Dr. Martin Luther King. When a person's own writings and/or the historical record of that person is not exactly on point to answer a query by a living or virtual questioner the virtual rendition presents an answer which is a best estimate answer based on the writings and data by others about the virtual person and extrapolating therefrom an appropriate response. Second hand data is data created by those who knew the historical figure personally, such as Plato's writings on Socrates. Third hand data is data created by some party who, at the time the data was recorded, had no direct personal knowledge of the historical person. One example of third hand data is a paper published in 2010 by a philosophy professor who postulates about Socrates' view on what characteristics and precepts might qualify a war as being just. The virtual presentation weighs first, second and third hand data differently. As a general principle first, second and third hand data are typically weighed progressively lower.

Within each first, second and third hand type of data there may be sub-types which are weighed differently still. For example, Madam Curie's writings on measuring radioactive decay is a topic for which she is renowned and in an embodiment of these teachings is given a higher rating than some topic on which she wrote but for which she is not famous nor an expert, such as for example different biological effects in humans of alpha versus gamma radiation. Second hand data may be weighed differently by how familiar the author was with the historical figure. For instance, data authored by President Reagan's speechwriter or press secretary would be in an exemplary embodiment weighed heavier than writings by a citizen whom the past president met on one or two occasions. Third person data may be weighed based on the extent of the writing or the number of works a particular writer has authored about a particular historical figure. For example a paper or book by an author who's written multiple works on Ptolemy will be given a greater weight than a mid-career professor who's written only one work referencing the astronomer. The weighing for a particular work can also depend on how extensively that work cites to the historical person and/or the specific topic of interest.

One non-limiting implementation to assign different weight to different works/sources found in the macro database 106 is to base the weight on how often other documents or references cross-cite to the subject work/source. For instance, a three volume treatise on Marx may have substantial references concerning Marx's view that capitalism is a temporary societal condition that will naturally be replaced by communism. For a virtual rendition of Marx on the topic of the superiority of communism over capitalism, the fact that there are an extensive number of references internal within the three volume treatise might engender a high internal weight for that three volume work/source. Examining how many other works/sources in the macro database 106 cross reference to that three volume treatise is an external weight that is additive with the internal weight so as to bias the three volume work more positively for greater inclusion in the virtual rendition of Marx on this topic. If the three volume work is substantially cross cited it will have a higher overall weight than if it were only lightly cross cited. These external cross cites may also be biased in their own weighing to favor external cross-citations that are non-contemporaneous, which tend to indicate that the three volume treatise has stood the test or time. Such external cross-citations may be further positively biased if their cross-reference to the three volume treatise is also relevant to the input topic, in this example Marx's view of communism being superior to capitalism.

Thus in one specific embodiment the weight of a third hand source, if sufficiently internally extensive respecting the topic at hand and also sufficiently validated by cross-citations by other sources, may exceed the weight of a second or even first-hand source which is less on point. The goal of this weighing is to structure data in the pre-fetch database 104 for rapid search and return of data that is most relevant to a highly targeted query in real time while the exchange with the virtual historical person is ongoing, such as in front of the physics class or assembled physicists in the above example. As noted above, that query may come from another virtually rendered person or from a live audience participant.

Now with the pre-fetch database 104 sufficiently populated, the historical person may be virtually rendered at 108 for the benefit of an audience. In various embodiments the virtual rendering may be audio only, or may be audio-visual in two dimensions (2D) onscreen or in three dimensions (3D) as a hologram or more compellingly as a three dimensional display such as a stereogram or stereoscope, volumetric displays, multiplexed parallax/lenticular sheet displays and the like. For case in which there are no available sources in the macro database 106 of still or moving images of the historical person him/herself, such as for example Jesus or Copernicus, the visual portion of the virtual rendering may be taken from artistic renderings. The artistic renderings also may be weighed according to second and third hand data principles where applicable. For instances in which the macro database 106 is bereft of audio recordings from the historical person, there may be little or no sources that postulate the vocal intonations and cadence of the historical person. In this case a more artistic license may be taken to provide a more life-like virtual rendition. Vocal characteristics for the virtual rendition 108 may be chosen by an AI system itself or may be extracted from a voiceover performed for the case where the macro database 106 is too sparse on this point. Additionally, in one embodiment either of these techniques may be used simply to make the overall presentation of the virtual rendering 108 more entertaining for the target audience, without subtracting from the substance of the historical person's contributions to human knowledge being presented to that audience.

In an exemplary embodiment of these teachings and similar to the above voice intonations and audible qualities, a historical person's conclusions on the topic/matter at hand, as determined from the pre-fetch database 104 and is presented in a virtual rendition consistent with the historical person's personality traits and their presentation style. Thus to the extent the historical data allows, the virtual historical person reflects the personality as well as the conclusions and/or thought processes of the actual historical person it represents. Of course there will be far more relevant data to construct a virtual rendition of a person that was alive more recently. For example, there will be far more relevant data to construct a virtual Ronald Reagan personality than one for a virtual Socrates, not least because there is actual audio and video of the former president while our knowledge of the one-time gadfly of Athens appears to rely wholly on the writings of only a handful of his contemporaries. However, if for example source data from the macro database 106 indicates the historical person sometimes became defensive when pressed for details on one aspect or another of a given topic, or had a commonly repeated response to different tactics of a debate partner, the virtual rendition could reflect that personality trait. Similarly, a historical person's known mannerisms may also be reflected in the virtual rendition depending upon the complexity of the pre-fetch database. For example, if there is source data detailing whether the historical person animated his/her presentations with hand gestures, or moved about the stage or remained fixed behind a lectern. Also, artistic license employed by extrapolating on the information in the pre-fetch database to supplement the virtual rendering to make it more realistic.

For all of the embodiments above, the subject matter culled from sources and retained in the pre-fetch database 104 including the voice intonations and quality, the personality traits and mannerisms of the historical person are presented to the audience in a virtual rendering 108. As noted above, this virtual rendering 108 may be audio only, or some combination of audio and visual in two or three dimensional imaging. In all cases this virtual rending 108 is a tangible output, whether by electrical to audio transducer alone or with an accompanying visual output. Thus the virtual rendering 108 is a positive and tangible transformation of the data taken from the pre-fetch database 104. This is done to initiate a real-time debate/discussion/presentation 110 about the topic/subject matter from planning inputs 102 with either another virtual rendering of a historical person or in a more simple form a presentation to a passive audience.

While a real-time debate or discussion 110 according to embodiments of this invention is ongoing, certain real-time inputs/queries 112 can be presented to the virtual rendition of the historical person. In order to produce a lifelike performance these real-time inputs/queries 112 require a response in real-time. Accordingly, the structured pre-fetch database 104 is first consulted to find how the historical person would have responded or would probably respond. The pre-fetch database 104 will search not only potential responses by substance but will compile the personality and vocal intonation of the historical person provided the system is that detailed. Regardless of how structured or extensive the pre-fetch 104 is, implementation of this embodiment requires quite a bit of processing power. As such it follows that embodiments of this aspect utilizes at least an artificial intelligence system, massive parallel processors or both. The answer which is a best-fit substantive answer for the real-time input/query 112 from the pre-fetch database 104 is tested at a sufficiency check 114 for appropriateness and completeness with respect to the real-time input/query 112. This analysis can be performed as another AI type analysis. If the substantive answer from the pre-fetch database 104 is sufficiently appropriate and complete, the answer is formed into a response at block 110. As is evident, the query and response has essentially been constrained in FIG. 1 within the closed loop of the pre-fetch database 104. The purpose and structuring of data stored at the pre-fetch database 104 is intended to provide answers to anticipated queries so these previously contemplated responses can be readily obtained without delay.

It should be noted that embodiments of the real-time inputs/queries 112 are not limited to challenges or questions from an audience or from other virtual renditions. The real-time inputs/queries 112 may also be in the form of changes in the environment around the virtual rendition. For instance, a virtual rendition of Michael Faraday might respond and/or narrate changes in electric charges in a classroom experiment involving electrodes. As such, the real-time inputs/queries 112 is operable to except or respond to other forms of inputs.

If the substantive answer from the pre-fetch database 106 is not sufficiently appropriate or complete, then in an exemplary non-limiting embodiment of the system performs in parallel two distinct actions. First a stalling tactic is imposed on the real time performance 110 of the virtual rendition 108. An example stalling tactic would be asking the querying party for clarification or more detail, or having the virtual rendition repeat a bit of the discussion which led up to the input/query 112 now being processed. Second, the processing system can also look to the macro database 106 for additional data that, which when used alone or in addition to the weighed data already in the pre-fetch database 104, will enable the answer to pass the sufficiency check 114. This is the most likely progression through FIG. 1 if the query 112 is not an anticipated answer during the time the pre-fetch database 104 is being populated.

FIG. 1 may be considered to illustrate the operation of a method, a result of execution of computer program instructions comprising code stored in a computer readable memory on a processing system, and a specific manner in which components of an apparatus are configured to cause that apparatus to operate. The pre-fetch database 104 may be a part of the apparatus or processing system or it can be controlled by it.

The various blocks shown at FIG. 1 may also be considered as a plurality of coupled logic circuit elements constructed to carry out the associated function(s), or specific result of strings of computer program code or instructions stored in a memory. Such blocks and the functions they represent are non-limiting examples, and may be practiced in various components such as integrated circuit chips and modules, and that the exemplary embodiments of this invention may be realized in an apparatus or system that comprises circuitry as well as possibly tangibly embodied firmware for embodying at least one or more of a data processor or data processors that are configurable by tangibly embodied operating and program software so as to operate in accordance with the exemplary embodiments of this invention.

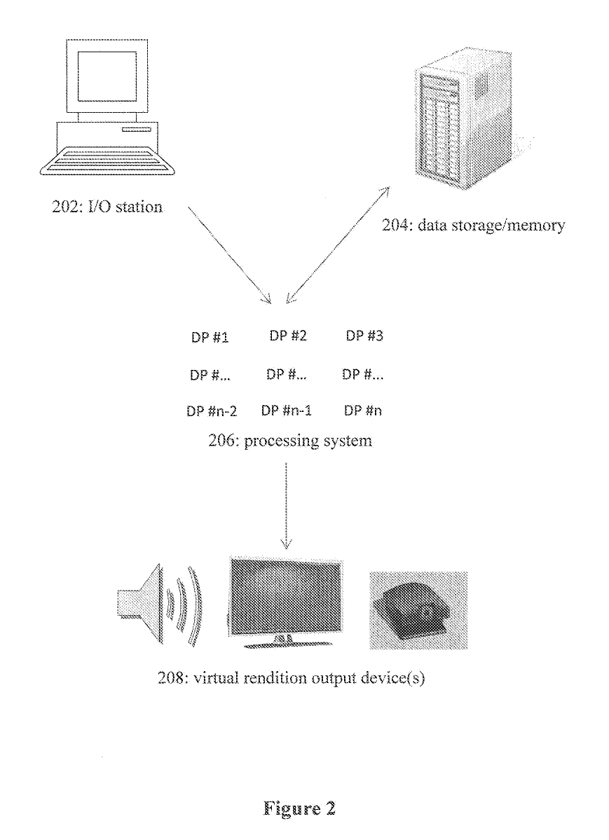

Reference is now made to FIG. 2 for illustrating a simplified block diagram of a computing system which is an exemplary non-limiting embodiment for implementing these teachings. There is an input station 202 such as for example a computer workstation or laptop with a keyboard, touch screen or voice recognition input device. A memory 204 stores operating instructions such as a computer program for controlling one or more processors to take actions to implement these teachings as is detailed by example above. The pre-fetch database may also be stored in the memory 204 with the operating program. The processing system 206 may itself comprise multiple and/or massive parallel processors of which there are an integer number n of digital processors shown, or one or more processors which operate using AI. Finally there is one of more virtual rendition output devices 208, such as for example a speaker system, a two-dimensional display, a projector, or any of the various devices for rendering a three dimensional display. The processing system 206 may also include a modem for two-way communication with the internet for searching the macro database as detailed above.

At least one of the programs stored in the memory 204 is assumed to include a set of program instructions that, when executed by one or more of the digital processors DPs in the processing system 206, enable the computer system to operate in accordance with the exemplary embodiments of this invention, as detailed above, in these regards the exemplary embodiments of this invention may be implemented at least in part by computer software stored on the memory 204 which is executable by one or more of the digital processors, or by hardware, or by a combination of tangibly stored software and hardware (and tangibly stored firmware).

Various embodiments of the computer readable memory 204 include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the individual data processors include but are not limited to general purpose computers, special purpose computers, microprocessors, digital signal processors and multi-core processors.

Some of the various features of the above non-limiting embodiments may be used to advantage without the corresponding use of other described features. The foregoing description should therefore be considered as merely illustrative of the principles, teachings and exemplary embodiments of this invention, and not in limitation thereof.

What is claimed is:

1. A method for presenting an interactive virtual rendition of an historical person, the method comprising;
compiling a pre-fetch database about the historical person comprising one or more writings, audio and video records of or about the historical person;
presenting a multimedia virtual rendering of the historical person, the rendering comprising at least audio content and at least one of personal mannerisms and personality traits derived from the pre-fetch database as attributed to the historical person; and
in response to real-time inputs from interaction with the virtual rendering of the historical person, using at least the pre-fetch database to compile a reply to the real time inputs, the compiled reply comprising at least one of audio content and personal mannerisms that are selected and virtually rendered in dependence on the real-time inputs.

2. The method according to claim 1, wherein the real-time inputs consists of at least one of a historical person, a topic/subject matter, a target audience and a query.

3. The method according to claim 1, wherein the pre-fetch database uses a weighing system to determine importance of the one or more writings, audio and video records of or about the historical person, wherein the weighing system ranks first, second and third hand writings, audio and video records.

4. The method according to claim 1, wherein the real-time input is from at least one of a live person, a video conference with a live person, and an interactive virtual rendition of a different historical person.

5. The method according to claim 1, wherein the method further comprises checking the sufficiency of the reply in relation to the real-time inputs and for the case that the reply is not sufficient performing a stalling tactic, wherein the stalling tactic is a multimedia virtual rendering of the historical person comprising audio content and at least one of personal mannerisms and personality traits derived from the pre-fetch database as attributed to the historical person which is not responsive to the input.

6. The method according to claim 1, wherein the reply is compiled by first looking to the pre-fetch database and second looking to the internet or an artificial intelligence computing system.

7. An apparatus for presenting an interactive virtual rendition of a historical person, the apparatus comprising a processing system;
the processing system comprising at least one processor, and at least one memory including computer program code,
wherein the processing system is configured to cause the apparatus at least to:
compile a pre-fetch database about the historical person comprising one or more writings, audio and video records of or about the historical person;
present a multimedia virtual rendering of the historical person, the rendering comprising at least audio content and at least one of personal mannerisms and personality traits derived from the pre-fetch database as attributed to the historical person; and
in response to real-time inputs from interaction with the virtual rendering of the historical person, use at least the pre-fetch database to compile a reply to the real time inputs, the compiled reply comprising at least one of audio content and personal mannerisms that are selected and virtually rendered in dependence on the real-time inputs,

8. The apparatus according to claim 7, wherein the real-time inputs consists of at least one of a historical person, a topic/subject matter, a target audience and a query.

9. The apparatus according to claim 7, wherein the pre-fetch database uses a weighing system to determine an importance of the one or more writings, audio and video records of or about the historical person, wherein the weighing system ranks first, second and third hand writings, audio and video records.

10. The apparatus according to claim 7, wherein the real-time input is from at least one of a live person, a video conference with a live person, and an interactive virtual rendition of a different historical person.

11. The apparatus according to claim 7, wherein the processing system is further configured to cause the apparatus to check the sufficiency of the reply in relation to the real-time inputs and for the case that the reply is not sufficient performing a stalling tactic, wherein the stalling tactic is a multimedia virtual rendering of the historical person comprising at least audio content and at least one of personal mannerisms and personality traits derived from the pre-fetch database as attributed to the historical person which is not responsive to the real-time inputs.

12. The apparatus according to claim 7, wherein the reply is compiled by first looking to the pre-fetch database and second looking to the internet or an artificial intelligence computing system.

13. A computer readable memory tangibly storing a set of computer instructions comprising code, which, when executed by a processing system, cause the processing system at least to:
compile a pre-fetch database about the historical person comprising one or more writings, audio and video records of or about the historical person;
present a multimedia virtual rendering of the historical person, the rendering comprising at least audio content and at least one of personal mannerisms and personality traits derived from the pre-fetch database as attributed to the historical person; and
in response to real-time inputs from interaction with the virtual rendering of the historical person, use at least the pre-fetch database to compile a reply to the real time inputs, the compiled reply comprising at least one of audio content and personal mannerisms that are selected and virtually rendered in dependence on the real-time inputs.

14. The computer readable memory according to claim 13, wherein the real-time inputs consists of at least one of a historical person, a topic/subject matter, a target audience and a query.

15. The computer readable memory according to claim 13, wherein the pre-fetch database uses a weighing system to determine an importance of the one or more writings, audio and video records of or about the historical person, wherein the weighing system ranks first, second and third hand writings, audio and video records.

16. The computer readable memory according to claim 13, wherein the real-time input is from at least one of a live person, a video conference with a live person, and an interactive virtual rendition of a different historical person.

17. The computer readable memory according to claim 13, wherein the processing system is further configured to check the sufficiency of the reply in relation to the real-time inputs and for the case that the reply is not sufficient performing a stalling tactic, wherein the stalling tactic is a multimedia virtual rendering of the historical person comprising at least audio content and at least one of personal mannerisms and personality traits derived from the pre-fetch database as attributed to the historical person which is not responsive to the real-time inputs.

18. The computer readable memory according to claim 13, wherein the reply is compiled by first looking to the pre-fetch database and second looking to the internet or an artificial intelligence computing system.
